(19) United States
(12) Patent Application Publication
(10) Pub. No.: US 2017/0093038 A1
(43) Pub. Date: Mar. 30, 2017

(54) BASE STATION, COMMUNICATION SYSTEM, AND BEAM CONTROL METHOD

(71) Applicant: FUJITSU LIMITED, Kawasaki-shi (JP)

(72) Inventors: Zhengyi Li, Shinagawa (JP); Yoji Ohashi, Fuchu (JP)

(73) Assignee: FUJITSU LIMITED, Kawasaki-shi (JP)

(21) Appl. No.: 15/244,108

(22) Filed: Aug. 23, 2016

(30) Foreign Application Priority Data
Sep. 25, 2015 (JP) 2015-188390

(51) Int. Cl. H01Q 3/36

(52) U.S. Cl. CPC H01Q 3/36

(57) ABSTRACT

A base station includes a plurality of antenna elements, a grouping module that forms a plurality of groups in which a plurality of mobile stations for which degree of mutual interference among the mobile stations is below a threshold are grouped in an identical group, and a forming module that simultaneously forms a plurality of beams for a plurality of mobile stations that belong to a single group for each group of the plurality of groups by using the plurality of antenna elements.

### CROSS-REFERENCE TO RELATED APPLICATION

This application is based upon and claims the benefit of priority of the prior Japanese Patent Application No. 2015-188390, filed on Sep. 25, 2015, the entire contents of which are incorporated herein by reference.

### FIELD

The embodiments discussed herein are related to a base station, a communication system, and a beam control method.

### BACKGROUND

Known are technologies to control a directional beam (hereinafter may simply be referred to as “beam”) by using an array antenna in which a plurality of antenna elements are arrayed. Furthermore, there are currently a number of related standards of millimeter wave communication such as 802.15.3c and 802.11ad.

In the beam control defined in these related standards, a base station first selects a beam that is the best in signal power to noise power ratio (SNR) out of a number of wide beams, and then divides the selected best beam into a number of narrow beams and selects a beam of the best SNR out of the narrow beams after division. The base station repeatedly performs such division and selection of the beam, and forms a beam to ultimately use in communication.

Examples of related-art are described in Japanese National Publication of International Patent Application No. 2008-547275, in Japanese National Publication of International Patent Application No. 2010-503365, in Principles of IEEE 802.15.3c: Multi-Gigabit Millimeter-Wave Wireless PAN, IEEE ICCCN 2009, 2009, and in IEEE Std. 802.11ad™-2012.

While such beam control as in the foregoing is suitable for communication in which the number of mobile stations that simultaneously perform communication with a single base station is one (that is, single user communication), it is not suitable for communication in which the number of mobile stations with which a single base station simultaneously performs communication is plural (that is, multi-user communication). This is because mutual interference among the mobile stations may occur in the case of multi-user communication and a signal power to interference power ratio (SIR) may become low even when the SNR is high. Consequently, in the case of multi-user communication, it becomes difficult to form an optimal beam because a beam of a low SIR may be formed when the beam is controlled based on the SNR as in the foregoing. When an optimal beam is not formed, a throughput deteriorates.

### SUMMARY

According to an aspect of an embodiment, a base station includes a plurality of antenna elements, a grouping module that forms a plurality of groups in which a plurality of mobile stations for which degree of mutual interference among the mobile stations is below a threshold are grouped in an identical group, and a forming module that simultaneously forms a plurality of beams for a plurality of mobile stations that belong to a single group for each group of the plurality of groups by using the plurality of antenna elements.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a communication system according to a first embodiment;

FIG. 2 is a block diagram illustrating the configuration of a base station in the first embodiment;

FIG. 3 is a diagram illustrating a connection example performed by a connection switch in the first embodiment;

FIG. 4 is a block diagram illustrating the function of a processor in the first embodiment;

FIG. 5 is a diagram for explaining direction-of-arrival estimation in the first embodiment;

FIG. 6 is a chart illustrating beam patterns in the first embodiment;

FIG. 7 is a table illustrating a beam pattern table in the first embodiment;

FIG. 8 is a diagram for explaining the operation of the base station in the first embodiment;

FIG. 9 is a diagram for explaining the operation of the base station in the first embodiment;

FIG. 10 is a flowchart for explaining the processing of the base station in the first embodiment;

FIG. 11 is a block diagram illustrating the function of a processor in a second embodiment;

FIG. 12 is a block diagram for explaining the operation of a base station in the second embodiment; and

FIG. 13 is a diagram for explaining the operation of the base station in the second embodiment.

### DESCRIPTION OF EMBODIMENTS

Preferred embodiments of the present invention will be explained with reference to accompanying drawings. Note that the invention is not intended to be limited by the embodiments. While the disclosed technology is suitable for millimeter wave communication, it is also applicable to the communication other than the millimeter wave communication. For those constituent elements having an identical function in the respective embodiments, the identical letters or numerals are given and the redundant explanations thereof are omitted.

### [a] First Embodiment

Configuration of Communication System

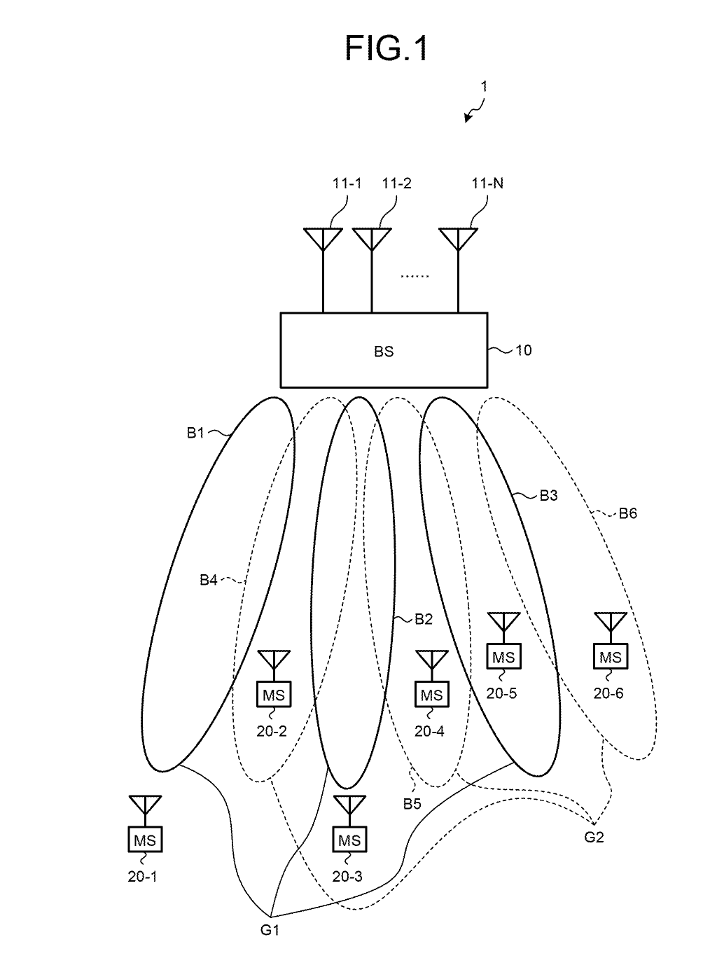

FIG. 1 is a diagram illustrating the configuration of a communication system according to a first embodiment. In FIG. 1, a communication system 1 includes a base station (BS) 10, and mobile stations (MSs) 20-1 to 20-6. While six MSs are presented in FIG. 1 as one example, the number of MSs that the communication system 1 includes is not limited. In the following description, in the case of not specifically distinguishing the MSs 20-1 to 20-6, they may be collectively referred to as MSs 20.

The BS 10 includes an array antenna in which antenna elements 11-1 to 11-N (N is an integer of two or larger) are arrayed, and forms beams for the respective MSs 20 by using the antenna elements 11-1 to 11-N.

It is assumed that the degree of mutual interference among the MS 20-1, the MS 20-3, and the MS 20-5 is below a threshold. It is further assumed that the degree of mutual interference among the MS 20-2, the MS 20-4, and the MS 20-6 is below the threshold. Consequently, the BS 10 forms a group G1 in which the MS 20-1, the MS 20-3, and the MS 20-5 are grouped in the identical group. The BS 10 further forms a group G2 in which the MS 20-2, the MS 20-4, and the MS 20-6 are grouped in the identical group. The group G1 and the group G2 are of different groups.

The BS 10 then simultaneously forms, for each group of the groups G1 and G2, a plurality of beams for a plurality of MSs 20 belonging to a single group.

That is, the BS 10 simultaneously forms three beams B1, B2, and B3 for each of the MS 20-1, the MS 20-3, and the MS 20-5 that belong to the group G1 at time t1 and simultaneously forms three beams B4, B5, and B6 for each of the MS 20-2, the MS 20-4, and the MS 20-6 that belong to the group G2 at time t2 that is a different time from the time t1, for example.

Furthermore, the BS 10 simultaneously forms the three beams B1, B2, and B3 for each of the MS 20-1, the MS 20-3, and the MS 20-5 that belong to the group G1 at a frequency f1, and simultaneously forms the three beams B4, B5, and B6 for each of the MS 20-2, the MS 20-4, and the MS 20-6 that belong to the group G2 at a frequency f2 that is a different frequency from the frequency f1, for example.

Configuration of Base Station

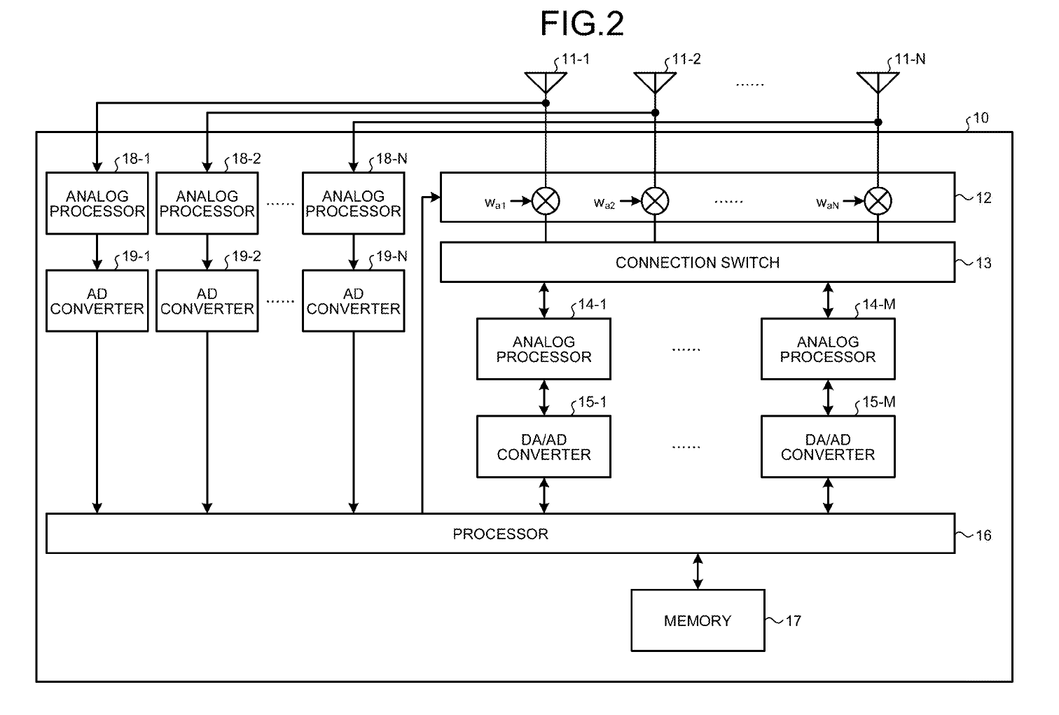

FIG. 2 is a block diagram illustrating the configuration of the base station in the first embodiment. In FIG. 2, the BS 10 includes the antenna elements 11-1 to 11-N, a phase shifter 12, a connection switch 13, analog processors 14-1 to 14-M (M is an integer of two or larger and smaller than N), DA/AD converters 15-1 to 15-M, a processor 16, and a memory 17. The BS 10 also includes analog processors 18-1 to 18-N and AD converters 19-1 to 19-N. One example of the processor 16 includes a central processing unit (CPU), a digital signal processor (DSP), and a field programmable gate array (FPGA). One example of the memory 17 includes a ROM, a flash memory, and a RAM such as an SDRAM.

The antenna elements 11-1 to 11-N are lined up in a straight line and form an antenna array. A distance d between the respective antenna elements is defined as one half the wavelength λ of a radio wave that is transmitted and received, for example.

The phase shifter 12 forms a beam by weighting the antenna elements 11-1 to 11-N by weight coefficients wₐ₁ to w_{aN}. At this time, the phase shifter 12 forms the beam by using the weight coefficients wₐ₁ to w_{aN} received from the processor 16. A weight coefficient wₐₙ (n is an integer between one and N) can be expressed by the following Expression 1, for example. In Expression 1, the e represents the base of natural logarithm, the j represents an imaginary unit, the d represents the distance between the antenna elements, and the λ represents the wavelength of the radio wave. The θ in Expression 1 is described later. By weighting the antenna elements 11-1 to 11-N by such weight coefficients wₐ₁ to w_{aN} the phases of the radio waves that are emitted in the direction of θ or that enter from the direction of θ are aligned on the respective antenna elements 11-1 to 11-N, and thus a beam is formed in the direction of θ.

$${W}_{an} = {e}^{j 2 π ( n - 1 ) \frac{d}{λ} si n θ} \qquad ( 1 )$$

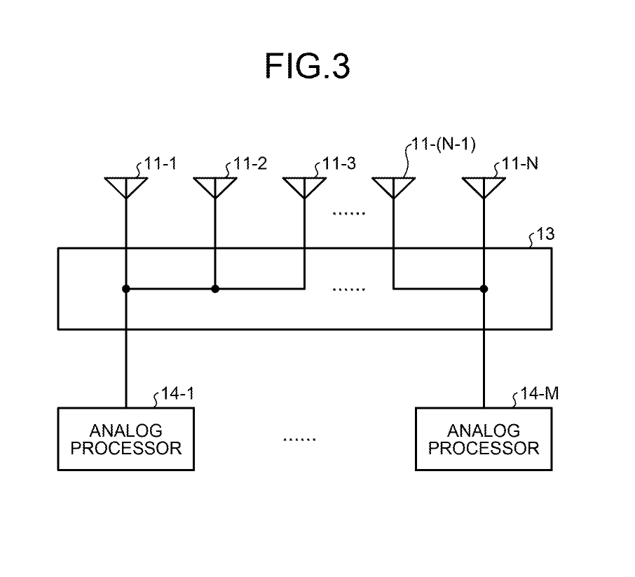

The connection switch 13 connects the antenna elements 11-1 to 11-N to the analog processors 14-1 to 14-M. For example, as illustrated in FIG. 3, the connection switch 13 connects the analog processor 14-1 to the three antenna elements of the antenna elements 11-1 to 11-3, and connects the analog processor 14-M to the two antenna elements of the antenna element 11-(N-1) and 11-N.

Referring back to FIG. 2, the analog processors 14-1 to 14-M perform a given analog processing on a transmission signal and a received signal. For example, the analog processors 14-1 to 14-M perform up-conversion on the transmission signal and amplify it, and perform down-conversion on the received signal.

The DA/AD converters 15-1 to 15-M perform DA conversion or AD conversion on a transmission signal and a received signal. That is, the DA/AD converters 15-1 to 15-M perform DA conversion on a transmission signal output from the processor 16, and output the obtained analog signal to the analog processors 14-1 to 14-M. The DA/AD converters 15-1 to 15-M further perform AD conversion on a received signal output from the analog processors 14-1 to 14-M, and output the obtained digital signal to the processor 16.

The analog processors 18-1 to 18-N perform given analog processing on respective received signals received from the antenna elements 11-1 to 11-N. For example, the analog processors 18-1 to 18-N perform down-conversion on the received signals.

The AD converters 19-1 to 19-N perform AD conversion on received signals. That is, the AD converters 19-1 to 19-N perform AD conversion on respective received signals output from the analog processors 18-1 to 18-N, and output the obtained digital signals to the processor 16.

The processor 16 estimates the location of each of the MSs 20 by estimating the direction of arrival of the received signals from the MSs 20, and calculates the weight coefficients wₐ₁ to w_{aN} for directing the beams toward the respective MSs 20. At this time, the processor 16 estimates the degree of mutual interference among the MSs 20, and performs grouping on the MSs 20 based on the estimated degree of interference. The processor 16 then determines, for each group, the weight coefficients to form the beams.

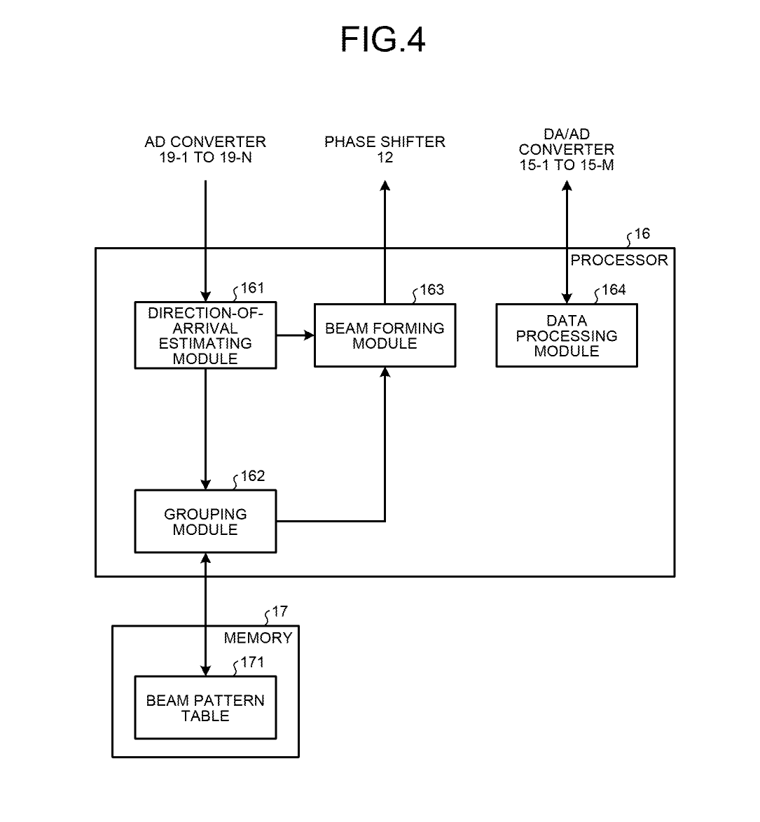

For example, as illustrated in FIG. 4, the processor 16 includes a direction-of-arrival estimating module 161, a grouping module 162, a beam forming module 163, and a data processing module 164. The memory 17 stores therein a beam pattern table 171.

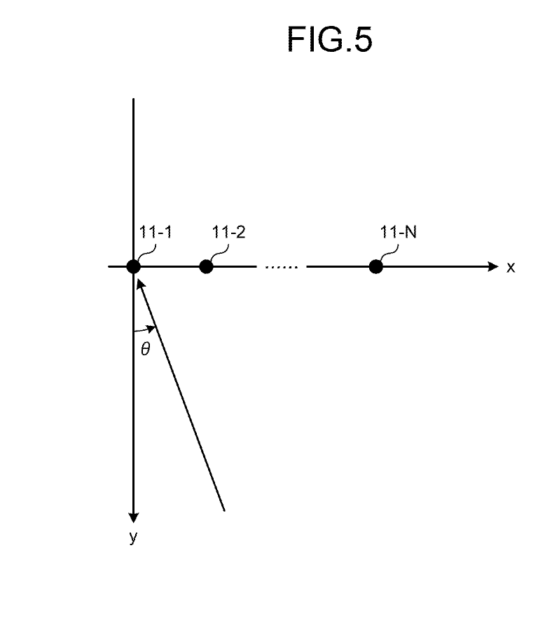

The direction-of-arrival estimating module 161 estimates the direction of arrival of each of a plurality of signals received from each of a plurality of MSs 20. The direction-of-arrival estimating module 161 receives received signals after AD conversion from the AD converters 19-1 to 19-N. As illustrated in FIG. 5, the direction-of-arrival estimating module 161 obtains, as an angle to represent the arrival direction of a received signal (that is, an arrival angle), an angle θ formed between a direction y perpendicular to an array direction x of the antenna elements 11-1 to 11-N and the arrival direction of the received signal. That is, the direction-of-arrival estimating module 161 calculates, by defining as zero degrees the direction y perpendicular to the array direction x in which the antenna elements 11-1 to 11-N are lined up, the angle θ formed from this direction y as the arrival direction of the received signal. For example, the direction-of-arrival estimating module 161 calculates the arrival angle θ from a reception delay difference between two signals that are transmitted from the identical MS 20 and received by two antenna elements being next to each other in the antenna elements 11-1 to 11-N. The direction-of-arrival estimating module 161 outputs the respective estimated arrival directions, that is, the arrival angle θ calculated on the respective received signals, to the grouping module 162 and the beam forming module 163.

The grouping module 162 estimates the degree of mutual interference among the MSs 20 based on the arrival directions estimated by the direction-of-arrival estimating module 161, performs grouping on the MSs 20 by using the estimated degree of mutual interference, and forms a plurality of groups. For example, the grouping module 162 defines a single MS 20 as a reference MS, and makes the MSs 20, for which the degree of mutual interference with the reference MS is below a threshold, belong to the group identical to that of the reference MS. The grouping module 162 then defines a reference MS in sequence and repeats determining whether the degree of mutual interference between the respective MSs 20 and the reference MS is below the threshold until all of the MSs 20 belong to any of the groups. The grouping module 162 performs grouping by using the beam pattern table 171 stored in the memory 17 when performing the grouping. The detail of the grouping processing performed by the grouping module 162 will be described later. The grouping module 162 outputs the result of grouping to the beam forming module 163.

The beam forming module 163 calculates the weight coefficients wₐ₁ w_{aN} on each group of the MSs 20 formed by the grouping module 162 according to the above-described Expression 1 based on the arrival angle θ calculated by the direction-of-arrival estimating module 161. The beam forming module 163 calculates for each group the weight coefficients wₐ₁ to w_{aN} to form beams pointing toward the respective directions of a plurality of MSs 20 belonging to the respective groups. The beam forming module 163 then outputs the calculated weight coefficients wₐ₁ to w_{aN} to the phase shifter 12.

The data processing module 164 generates a transmission signal by encoding and modulating data addressed to each of the MSs 20, and demodulates and decodes the received signal received from each of the MSs 20. The data processing module 164 can perform processing on signals from M respective channels. At this time, the data processing module 164 may generate in a lump the transmission signals addressed to a plurality of MSs 20 for each group according to the grouping performed by the grouping module 162, for example. The data processing module 164 may, according to the grouping performed by the grouping module 162, perform scheduling such that each of the MSs 20 for each group transmits a signal addressed to the base station 10 at the same time, and generate control signals that notify the respective MSs 20 of the scheduling result, for example.

Grouping Processing

Next, the grouping processing performed by the grouping module 162 will be described in detail.

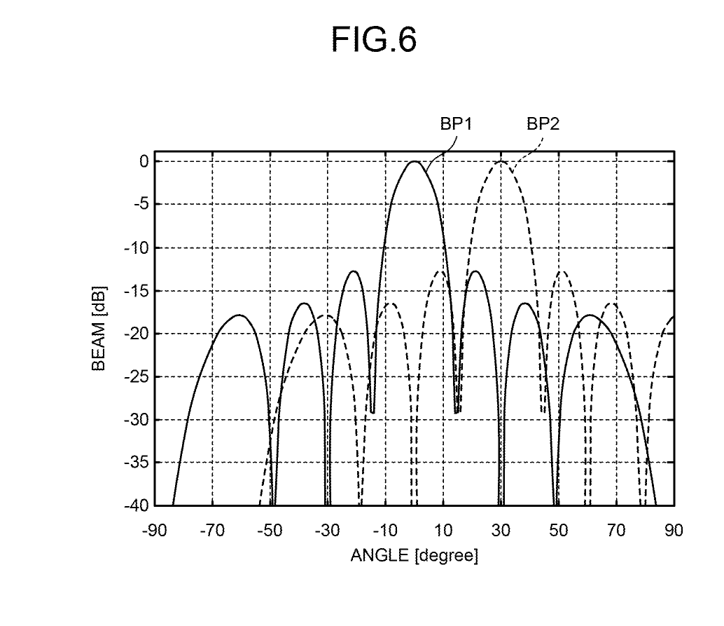

FIG. 6 is a chart illustrating beam patterns in the first embodiment. In FIG. 6, the beam patterns that are normalized to 0 dB are represented. In FIG. 6, a beam pattern BP1 in a case that a main beam is pointed to the MS 20 located in the direction of an arrival angle of 0 degrees, and a beam pattern BP2 in a case that a main beam is pointed to the MS 20 located in the direction of an arrival angle of 30 degrees are represented, as one example. The beam pattern BP1 and the beam pattern BP2 have an identical shape, and the beam pattern BP2 is one that the beam pattern BP1 is made to shift to the right on FIG. 6. The beam pattern BP1 and the beam pattern BP2 are formed by the antenna elements 11-1 to 11-N that are weighted by the weight coefficients wₐ₁ to w_{aN}.

In the beam pattern BP1, nulls are present near ±30 degrees and near ±50 degrees. Consequently, as illustrated in FIG. 6, when an angular difference of the main beam of the beam pattern BP2 with respect to the main beam of the beam pattern BP1 is 30 degrees, the SIR of the beam pattern BP2 with respect to the beam pattern BP1 is maximized. The SIR is one of the indices that represent the degree of interference, and as the SIR becomes larger, the degree of interference becomes smaller. Hence, when the angular difference of the main beam of the beam pattern BP2 with respect to the main beam of the beam pattern BP1 is 30 degrees, the degree of interference of the beam pattern BP1 with respect to the beam pattern BP2 is minimized.

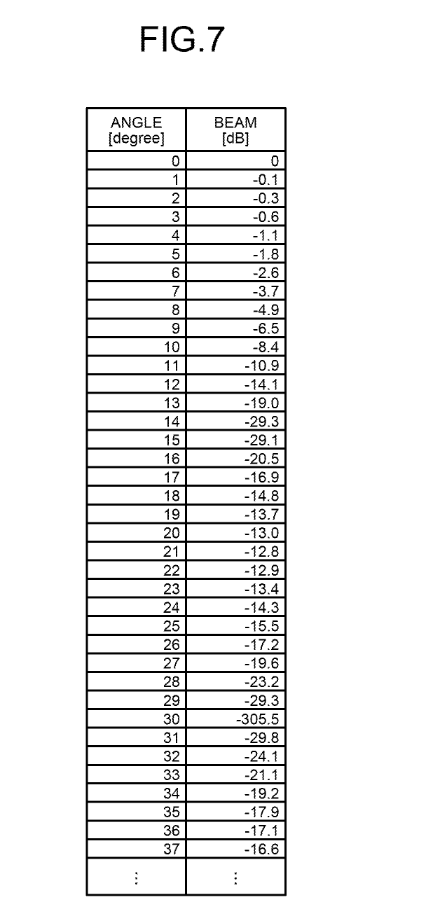

Consequently, the beam pattern table 171 representing the correspondence relation between the intensity (dB) and angle in the beam pattern BP1 that is illustrated in FIG. 6 is stored in the memory 17. In FIG. 7, one example of the beam pattern table 171 is illustrated. The grouping module 162 then refers to the beam pattern table 171 and performs grouping on the MSs 20 in the following manner.

That is, the grouping module 162 defines a single MS 20 out of a plurality of MSs 20 as a reference MS and acquires, from the direction-of-arrival estimating module 161, an arrival angle θs of the reference MS and an arrival angle θi of a single MS other than the reference MS (may be referred to as “grouping target MS” hereinafter). After that, the grouping module 162 obtains an absolute value |θs−θi| of the difference between the arrival angle θs and the arrival angle θi. The grouping module 162, however, obtains the |θs−θi| as an integer value by rounding down to the nearest integer or rounding up to the nearest integer, for example.

The magnitude of SIR of a grouping target MS located in the direction of the arrival angle θᵢ with respect to the reference MS located in the direction of the arrival angle θₛ is, as is apparent from the beam patterns illustrated in FIG. 6, dependent on the difference between the arrival angle θₛ and the arrival angle θᵢ. Consequently, the grouping module 162 estimates the SIR of the grouping target MS with respect to the reference MS according to the following Expression 2 by referring to the beam pattern table 171 (FIG. 7) based on the |θₛ−θᵢ|. The |θₛ−θᵢ| in Expression 2 corresponds to “Angle” in FIG. 7, and the “Beam” in Expression 2 corresponds to the “Beam” in FIG. 7. Consequently, the SIR is estimated to be 29.1 dB when the |θₛ−θᵢ| is 15 degrees, and the SIR is estimated to be 8.4 dB when the |θₛ−θᵢ| is 10 degrees, for example.

SIR=−Beam(|θₛ−θᵢ|) (2)

The grouping module 162 then determines whether the SIR estimated according to Expression 2 (that is, the SIR of the grouping target MS with respect to the reference MS) is equal to or greater than a threshold. The grouping module 162, when the SIR estimated according to Expression 2 is equal to or greater than the threshold, makes the grouping target MS belong to the group identical to that of the reference MS. Because the SIR is calculated to be 29.1 dB when the |θₛ−θᵢ| is 15 degrees, if the threshold of the SIR is, for example, 20 dB, the grouping module 162 makes the grouping target MS belong to the group identical to that of the reference MS. Because the SIR is calculated to be 8.4 dB when the |θₛ−θᵢ| is 10 degrees, if the threshold of the SIR is, for example, 20 dB, the grouping module 162 does not make the grouping target MS belong to the group identical to that of the reference MS.

As in the foregoing, the SIR is one of the indices that represent the degree of interference, and as the SIR becomes larger, the degree of interference becomes smaller. Thus, estimating the SIR according to the foregoing Expression 2 corresponds to estimating the degree of interference of the reference MS with respect to the grouping target MS. Furthermore, determining whether the SIR estimated according to the foregoing Expression 2 is equal to or greater than a threshold corresponds to determining whether the degree of interference of the reference MS with respect to the grouping target MS is below a threshold. Consequently, in other words, the grouping module 162, when the degree of interference of the reference MS with respect to the grouping target MS is below the threshold, makes the grouping target MS belong to the group identical to that of the reference MS. The threshold of the degree of interference assumes a different value from the threshold of the SIR.

The grouping module 162 performs grouping on the MSs 20 as in the foregoing with all of the MSs 20 included in the communication system 1 as the reference MS and the grouping target MS based on the SIR estimated according to the foregoing Expression 2. Consequently, in each of a plurality of groups formed by the grouping module 162, on all of the MSs 20 belonging to a single group, the mutual SIR among the MSs 20 is equal to or greater than the threshold, that is, the degree of mutual interference among the MSs 20 is below the threshold.

Operation of Base Station

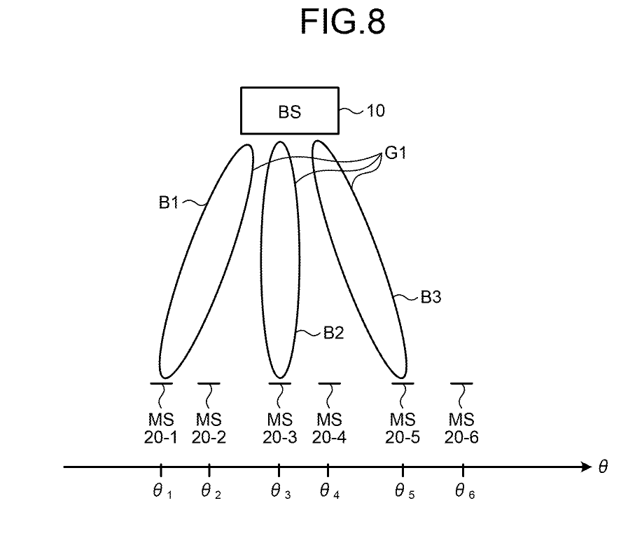

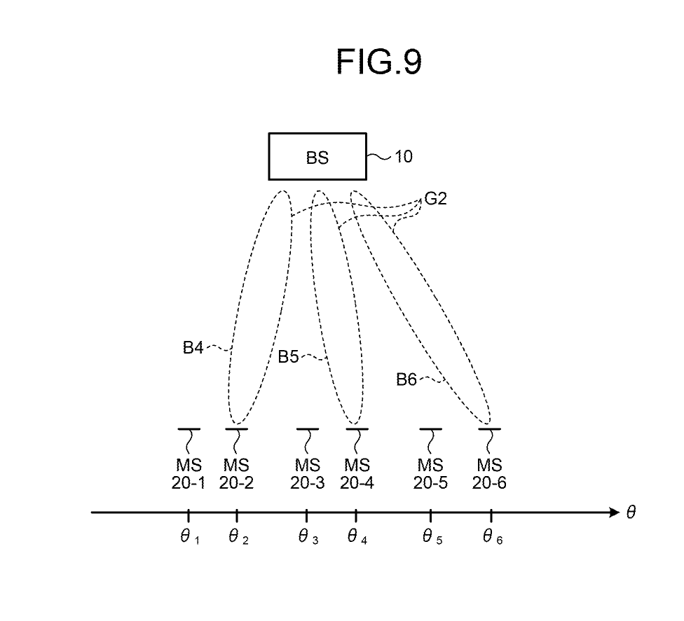

FIGS. 8 and 9 are diagrams for explaining the operation of the base station in the first embodiment.

As illustrated in FIGS. 8 and 9, the BS 10 first obtains respective arrival angles θ₁ to θ₆ of the MSs 20-1 to 20-6. The BS 10 defines each of the MSs 20-1 to 20-6 as the reference MS and the grouping target MS, and estimates the mutual SIR among the MSs 20 according to the foregoing Expression 2. It is assumed here that the mutual SIR among the MS 20-1, the MS 20-3, and the MS 20-5 is greater than a threshold and the mutual SIR among the MS 20-2, the MS 20-4, and the MS 20-6 is greater than the threshold. Consequently, the BS 10 makes the MS 20-1, the MS 20-3, and the MS 20-5 belong to the identical group G1. The BS 10 further makes the MS 20-2, the MS 20-4, and the MS 20-6 belong to the identical group G2. The group G1 and the group G2 are of different groups.

The BS 10 then simultaneously forms, for each group of the groups G1 and G2, a plurality of beams for a plurality of MSs 20 belonging to a single group. The multi-user communication performed by simultaneously forming a plurality of beams for a plurality of MSs may be referred to as “beam division multiple access (BDMA) communication.”

That is, as illustrated in FIG. 8, at time t1, the BS 10 simultaneously forms three beams B1, B2, and B3 for the MS 20-1, the MS 20-3, and the MS 20-5 belonging to the group G1 based on the arrival angles θ₁, θ₃, and θ₅, respectively, and performs BDMA communication with the MS 20-1, the MS 20-3, and the MS 20-5, for example. Furthermore, as illustrated in FIG. 9, at time t2 that is a different time from the time tl, the BS 10 simultaneously forms three beams B4, B5, and B6 for the MS 20-2, the MS 20-4, and the MS 20-6 belonging to the group G2 based on the arrival angles θ₂, θ₄, and θ₆, respectively, and performs BDMA communication with the MS 20-2, the MS 20-4, and the MS 20-6. The beams B1 to B6 are each a main beam in a plurality of beam patterns of an identical shape and of directions different from one another.

The BS 10 may, by using frequencies f1 and f2 in place of the time t1 and t2, perform BDMA communication with the MS 20-1, the MS 20-3, and the MS 20-5 at the frequency f1 while performing BDMA communication with the MS 20-2, the MS 20-4, and the MS 20-6 at the frequency f2. The frequency f1 and the frequency f2 are of different frequencies.

Processing of Base Station

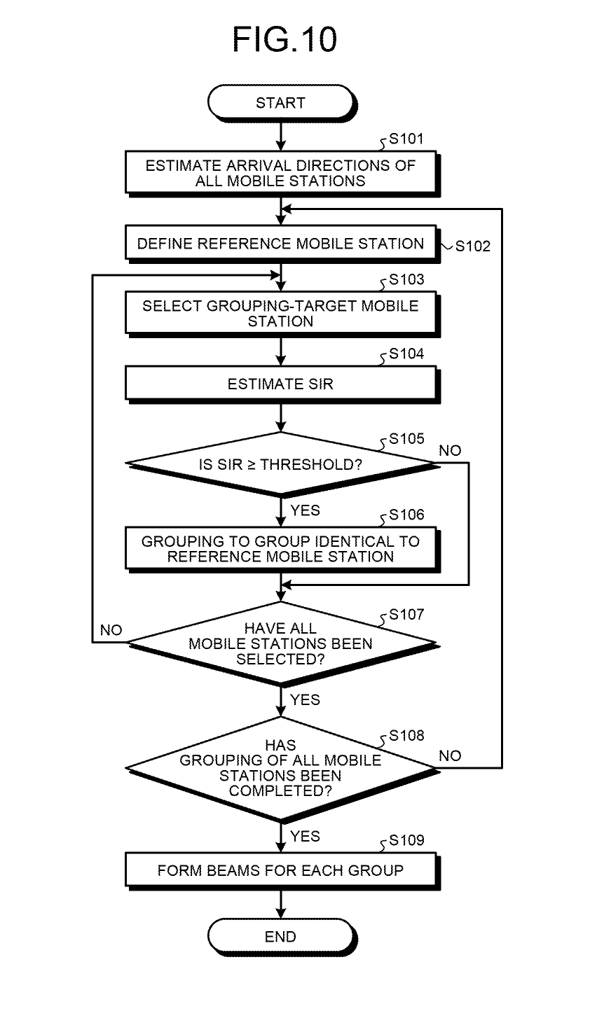

FIG. 10 is a flowchart for explaining the processing of the base station in the first embodiment.

When the BS 10 receives signals transmitted from a plurality of MSs 20, the arrival directions of the received signals from all of the MSs 20 are estimated (Step S101). Specifically, on the received signals received by the antenna elements 11-1 to 11-N, down-conversion is performed by the analog processors 14-1 to 14-M, and AD conversion is performed by the DA/AD converters 15-1 to 15-M. The obtained received signals in digital are input to the direction-of-arrival estimating module 161 of the processor 16, and the arrival directions of the respective received signals are estimated by the direction-of-arrival estimating module 161. At this time, as the arrival direction, an angle with respect to the direction perpendicular to the array direction of the antenna elements 11-1 to 11-N defined as zero degrees (that is, an arrival angle) is estimated. The arrival angle θ thus estimated is the angle representing the location of the respective MSs 20.

Then, the grouping module 162 defines any of the MSs 20 for which a group to belong is not yet determined as a reference MS (Step S102).

After that, the grouping module 162 selects any of the MSs 20 that is other than the reference MS and for which a group to belong is not yet determined, as a grouping target MS (Step S103).

Then, the grouping module 162 estimates the SIR of the grouping target MS with respect to the reference MS (Step S104).

Then, the grouping module 162 determines whether the estimated SIR at Step S104 is equal to or greater than a threshold (Step S105).

If the estimated SIR at Step S104 is equal to or greater than the threshold (Yes at Step S105), the grouping module 162 makes the grouping target MS belong to the group identical to that of the reference MS (Step S106). Meanwhile, if the estimated SIR at Step S104 is below the threshold (No at Step S105), the group to which the grouping target MS belongs is not determined and the processing is advanced to Step S107.

Then, the grouping module 162 determines whether all of the MSs 20 for which a group to belong is not determined have already been selected as a grouping target MS (Step S107). As a result of this determination, if the MSs 20 that are not yet selected are present (No at Step S107), the processing is returned to Step S103, and the grouping module 162 selects any of the MSs 20 out of the non-selected MSs 20 as a grouping target MS (Step S103), and in the same manner as that in the foregoing, determines whether the grouping target MS belongs to the group identical to that of the reference MS.

When all of the MSs 20 have already been selected as a grouping target MS (Yes at S107), the grouping module 162 determines whether the grouping on all of the MSs 20 has been completed as all of the MSs 20 belong to the group identical to that of any of the reference MSs (Step S108). As a result of this determination, if the MSs 20 that do not belong to any of the groups are still present (No at Step S108), the grouping module 162 defines any of the MSs 20 out of the MSs 20 that do not belong to any of the groups as a reference MS (Step S102), and in the same manner as that in the foregoing, determines whether the respective MSs 20 belong to the group identical to that of the reference MS.

When such grouping has been performed by the grouping module 162 and the grouping for all of the MSs 20 has been completed (Yes at S108), the beam forming module 163 calculates the weight coefficients for each group. The weight coefficients wₐ₁ to w_{aN} for each group calculated by the beam forming module 163 are output to the phase shifter 12 and are set to the respective antenna elements 11-1 to 11-N. Consequently, for each group, a plurality of beams for a plurality of MSs 20 belonging to a single group are simultaneously formed (Step S109).

Thereafter, transmitting and receiving of signals are performed between the BS 10 and the MSs 20 for each group, and at the time the transmitting and receiving of signals of the respective groups are performed, the weight coefficients wₐ₁ to w_{aN} of an appropriate group are set to the phase shifter 12.

As in the foregoing, in the first embodiment, the BS 10 includes the antenna elements 11-1 to 11-N, the grouping module 162, and the beam forming module 163. The grouping module 162 forms a plurality of groups in which a plurality of MSs for which the degree of mutual interference among the MSs is below a threshold are grouped in an identical group. The beam forming module 163 simultaneously forms a plurality of beams for a plurality of MSs that belong to a single group by using the antenna elements 11-1 to 11-N, for each group of the groups formed by the grouping module 162.

By doing this, the interference among the beams simultaneously formed within an identical group is suppressed, and thus the improvement in throughput in multi-user communication can be achieved.

Furthermore, in the first embodiment, the BS 10 includes the direction-of-arrival estimating module 161. The direction-of-arrival estimating module 161 estimates the arrival direction of each of a plurality of signals received from each of a plurality of MSs. The grouping module 162 estimates the degree of interference based on the beam patterns formed by the antenna elements 11-1 to 11-N and differences in angle representing the arrival direction among the MSs.

By doing this, the degree of mutual interference among the MSs can be estimated easily and accurately.

### [b] Second Embodiment

In the first embodiment, the SIR is estimated based on the differences in arrival angle among the MSs. Meanwhile, in a second embodiment, the SIR is estimated based on the differences in arrival angle among the MSs, and the differences in received power among the MSs in the BS.

Configuration of Base Station

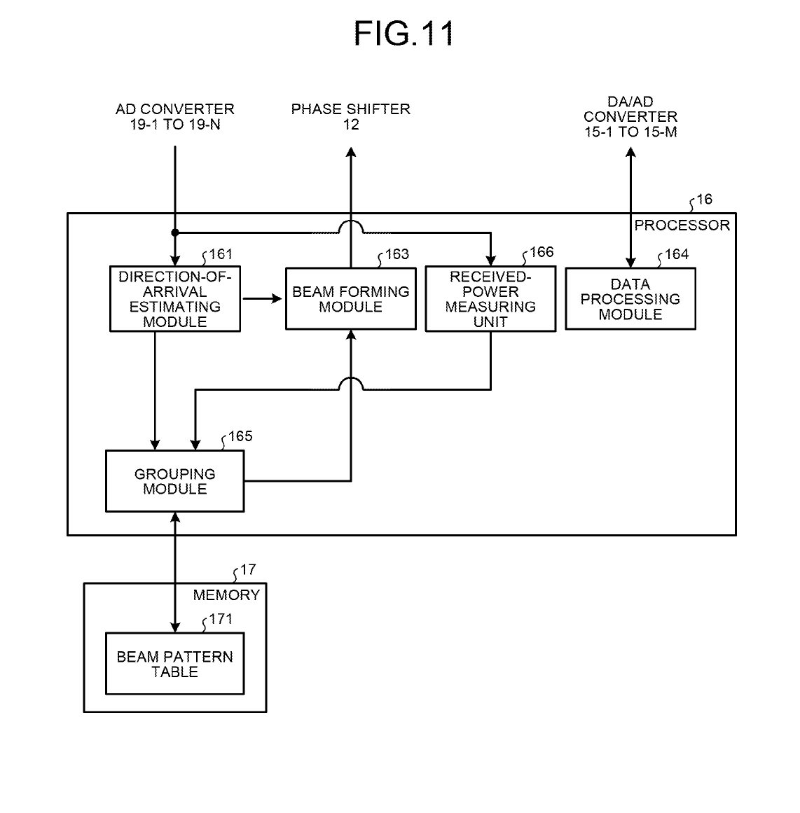

In the second embodiment, as illustrated in FIG. 11, the processor 16 includes the direction-of-arrival estimating module 161, a grouping module 165, the beam forming module 163, a received-power measuring unit 166, and the data processing module 164, for example.

The received-power measuring unit 166 measures received power of received signals output from the AD converters 19-1 to 19-N. The received-power measuring unit 166 measures the received power of each of a plurality of signals received from the respective MSs 20, and outputs the measured received power to the grouping module 165.

The grouping module 165 estimates the degree of mutual interference among the MSs 20 based on the arrival directions estimated by the direction-of-arrival estimating module 161 and the received power measured by the received-power measuring unit 166, performs grouping on the MSs 20 by using the estimated degree of mutual interference, and forms a plurality of groups.

Grouping Processing

Next, the grouping processing performed by the grouping module 165 will be described in detail.

The grouping module 165, as the same as the grouping module 162 in the first embodiment, defines a single MS 20 out of a plurality of MSs 20 as a reference MS, acquires the arrival angle θₛ of the reference MS and the arrival angle θᵢ of a grouping target MS from the direction-of-arrival estimating module 161, and obtains the absolute value |θₛ−θᵢ| of the difference between the arrival angle θₛ and the arrival angle θᵢ.

The grouping module 165 further acquires received power Pₛ of the received signal from the reference MS and received power Pᵢ of the received signal from the grouping target MS from the received-power measuring unit 166, and obtains an absolute value |Pₛ−Pᵢ| of the difference between the received power Pₛ and the received power Pᵢ.

The grouping module 165 then estimates the SIR of the grouping target MS located in the direction of the arrival angle θᵢ with respect to the reference MS located in the direction of the arrival angle θₛ according to the following Expression 3. The first term on the right-hand side in Expression 3 is identical to the first term on the right-hand side in the foregoing Expression 2. That is, the grouping module 165 estimates the SIR of the grouping target MS with respect to the reference MS by acquiring the SIR corresponding to the |θₛ−θᵢ| from the beam pattern table 171 (FIG. 7), and subtracting the |Pₛ−Pᵢ| from the acquired SIR. Consequently, the SIR acquired from the beam pattern table 171 is corrected by the |Pₛ−Pᵢ|.

SIR=−Beam(|θₛ−θᵢ|)−|Pₛ−Pᵢ| (3)

The subsequent processing is the same as that in the first embodiment.

The magnitude of the SIR of the grouping target MS with respect to the reference MS is dependent on not only the difference between the arrival angle θₛ and the arrival angle θᵢ but also the difference between the received power Pₛ and the received power Pᵢ. That is, as the received power Pᵢ is greater with respect to the received power Pₛ, the SIR of the grouping target MS with respect to the reference MS becomes greater. Consequently, estimating the mutual SIR among the MSs 20 by taking into consideration the difference in received power between the reference MS and the grouping target MS in this manner can achieve the improvement in estimate accuracy of the SIR. In other words, the improvement in estimate accuracy of the degree of mutual interference among the MSs 20 can be achieved.

Operation of Base Station

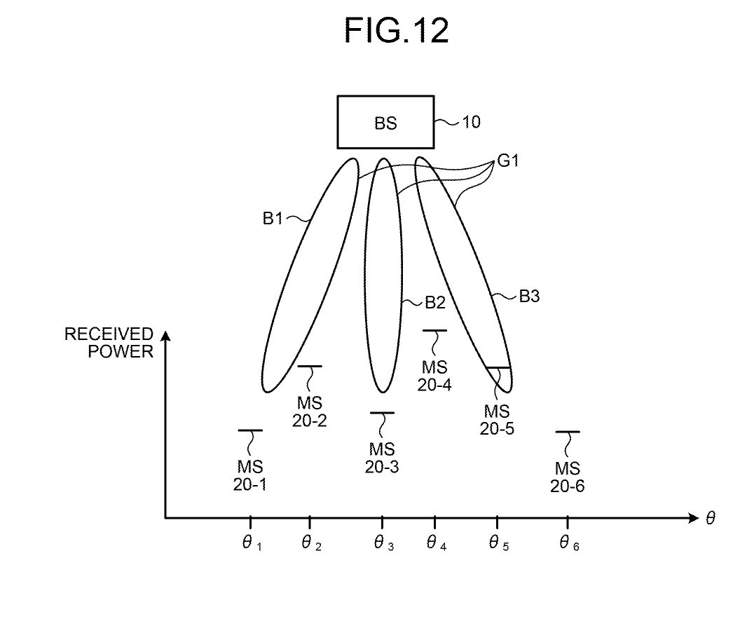

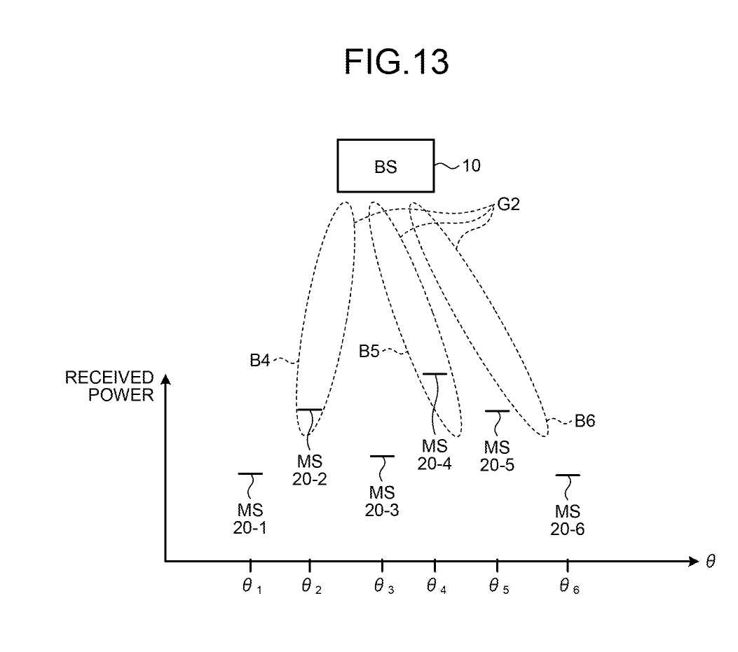

FIGS. 12 and 13 are diagrams for explaining the operation of the base station in the second embodiment.

As illustrated in FIGS. 12 and 13, in the second embodiment, the BS 10 first obtains the arrival angles θ₁ to θ₆ of the respective MSs 20-1 to 20-6 and measures received power P₁ to P₆ of the respective MSs 20-1 to 20-6. The BS 10 defines each of the MSs 20-1 to 20-6 as a reference MS and a grouping target MS and estimates the mutual SIR among the MSs 20 according to the foregoing Expression 3. It is assumed here that, as the same as those in the first embodiment, the mutual SIR among the MS 20-1, the MS 20-3, and the MS 20-5 is greater than a threshold and the mutual SIR among the MS 20-2, the MS 20-4, and the MS 20-6 is greater than the threshold. Consequently, the BS 10 makes the MS 20-1, the MS 20-3, and the MS 20-5 belong to the identical group G1. The BS 10 further makes the MS 20-2, the MS 20-4, and the MS 20-6 belong to the identical group G2. The subsequent operation is the same as that in the first embodiment.

As in the foregoing, in the second embodiment, the BS 10 includes the direction-of-arrival estimating module 161, the received-power measuring unit 166, and the grouping module 165. The direction-of-arrival estimating module 161 estimates the arrival direction of each of a plurality of signals received from each of a plurality of MSs. The received-power measuring unit 166 measures the received power of each of a plurality of signals received from the respective MSs. The grouping module 165 estimates the degree of interference based on the beam patterns formed by the antenna elements 11-1 to 11-N, the differences in angle representing the arrival directions among the MSs, and the differences in received power among the MSs.

By doing this, the improvement in estimate accuracy of the degree of mutual interference among the MSs can be achieved.

As in the foregoing, the first embodiment and the second embodiment have been explained.

The antenna elements 11-1 to 11-N, the phase shifter 12, the connection switch 13, the analog processors 14-1 to 14-M and 18-1 to 18-N, the DA/AD converters 15-1 to 15-M, and the AD converters 19-1 to 19-N can be implemented by a radio communication module as hardware.

According to one aspect of the disclosed embodiment, the improvement in throughput in multi-user communication can be achieved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a plurality of antenna elements;
a grouping module that forms a plurality of groups in which a plurality of mobile stations for which degree of mutual interference among the mobile stations is below a threshold are grouped in an identical group; and
a forming module that simultaneously forms a plurality of beams for a plurality of mobile stations that belong to a single group for each group of the plurality of groups by using the plurality of antenna elements.

2. The base station according to claim 1, further comprising an estimating module that estimates a direction of arrival of each of a plurality of signals received from each of a plurality of mobile stations, wherein
the grouping module estimates the degree of interference based on beam patterns formed by the plurality of antenna elements and difference in angle representing the direction of arrival among the mobile stations.

3. The base station according to claim 2, further comprising a measuring module that measures received power of each of the plurality of signals, wherein
the grouping module estimates the degree of interference based on the beam patterns, the difference in angle, and difference in the received power among the mobile stations.

4. A communication system comprising:
a base station; and
a plurality of mobile stations, wherein
the base station:
forms, on the mobile stations, a plurality of groups in which a plurality of mobile stations for which degree of mutual interference among the mobile stations is below a threshold are grouped in an identical group, and
simultaneously forms a plurality of beams for a plurality of mobile stations that belong to a single group for each group of the plurality of groups by using a plurality of antenna elements included in the base station.

5. A beam control method comprising:
forming a plurality of groups in which a plurality of mobile stations for which degree of mutual interference among the mobile stations is below a threshold are grouped in an identical group; and
simultaneously forming a plurality of beams for a plurality of mobile stations that belong to a single group for each group of the plurality of groups.
